(19) United States
(12) Patent Application Publication
(10) Pub. No.: US 2015/0074353 A1
(43) Pub. Date: Mar. 12, 2015

(54) System and Method for an Asynchronous Processor with Multiple Threading

(71) Applicant: Futurewei Technologies, Inc., Plano, TX (US)

(72) Inventors: Yiqun Ge, Kanata (CA); Wuxian Shi, Kanata (CA); Qifan Zhang, Lachine (CA); Tao Huang, Kanata (CA); Wen Tong, Ottawa (CA)

(21) Appl. No.: 14/476,535

(22) Filed: Sep. 3, 2014

Related U.S. Application Data
(60) Provisional application No. 61/874,860, filed on Sep. 6, 2013.

(51) Int. Cl. G06F 9/38; G06F 12/08; G06F 9/30

(52) U.S. Cl. CPC G06F 9/3838; G06F 9/3016; G06F 9/3004; G06F 12/0875; G06F 2212/452
USPC 711/125; 718/106

(57) ABSTRACT

Embodiments are provided for an asynchronous processor with multiple threading. The asynchronous processor includes a program counter (PC) logic and instruction cache unit comprising a plurality of PC logics configured to perform branch prediction and loop predication for a plurality of threads of instructions, and determine target PC addresses for caching the plurality of threads. The processor further comprises an instruction memory configured to cache the plurality of threads in accordance with the target PC addresses from the PC logic and instruction cache unit. The processor further includes a multi-threading (MT) scheduling unit configured to schedule and merge instruction flows for the plurality of threads from the instruction memory into a single combined thread of instructions. Additionally, a MT register window register is included to map operands in the plurality of threads to a plurality of corresponding register windows in a register file.

This application claims the benefit of U.S. Provisional Application No. 61/874,860 filed on Sep. 6, 2013 by Yiqun Ge et al. and entitled “Method and Apparatus of an Asynchronous Processor with Multiple Threading,” which is hereby incorporated herein by reference as if reproduced in its entirety.

### TECHNICAL FIELD

The present invention relates to asynchronous processing, and, in particular embodiments, to system and method for an asynchronous processor with multiple threading.

### BACKGROUND

Micropipeline is a basic component for asynchronous processor design. Important building blocks of the micropipeline include the RENDEZVOUS circuit such as, for example, a chain of Muller-C elements. A Muller-C element can allow data to be passed when the current computing logic stage is finished and the next computing logic stage is ready to start. Instead of using non-standard Muller-C elements to realize the handshaking protocol between two clockless (without using clock timing) computing circuit logics, the asynchronous processors replicate the whole processing block (including all computing logic stages) and use a series of tokens and token rings to simulate the pipeline. Each processing block contains a token processing logic to control the usage of tokens without time or clock synchronization between the computing logic stages. Thus, the processor design is referred to as an asynchronous or clockless processor design. The token ring regulates the access to system resources. The token processing logic accepts, holds, and passes tokens between each other in a sequential manner. When a token is held by a token processing logic, the block can be granted the exclusive access to a resource corresponding to that token, until the token is passed to a next token processing logic in the ring. There is a need for an improved and more efficient asynchronous processor architecture such as a processor capable for handling more computations over a time interval.

### SUMMARY OF THE INVENTION

In accordance with an embodiment, a method performed by an asynchronous processor includes receiving a plurality of threads of instructions from an execution unit of the asynchronous processor, and initiating, for the plurality of threads of instructions, a plurality of corresponding program counter (PC) logics at a PC logic and instruction cache unit of the asynchronous processor. The method further includes performing, using each one of the PC logics, branch prediction and loop predication for one corresponding thread of the plurality of threads of instructions, determining, using each one of the PC logics, a target PC address for the one corresponding thread, and caching the one corresponding thread in an instruction memory in accordance with the target PC address.

In accordance with another embodiment, a method performed at an asynchronous processor includes initiating, at a PC logic and instruction cache unit, a plurality of PC logics for handling multiple threads of instructions, and performing, using each one of the PC logics, branch prediction and loop predication for one corresponding thread of the multiple threads. The method further includes determining, using each one of the PC logics, a target PC address at an instruction memory for caching the one corresponding thread, and caching the one corresponding thread in the instruction memory in accordance with the target PC address. Additionally, instruction flows corresponding to the multiple threads from the instruction memory are scheduled and merged into a single combined thread of the instructions using a multi-threading (MT) scheduling unit.

In accordance with yet another embodiment, an apparatus for an asynchronous processor supporting multiple threading comprises a PC logic and instruction cache unit comprising a plurality of PC logics configured to perform branch prediction and loop predication for a plurality of threads of instructions, and determine target PC addresses for caching the plurality of threads. The apparatus further comprises an instruction memory configured to cache the plurality of threads in accordance with the target PC addresses from the PC logic and instruction cache unit. The apparatus further includes a multi-threading (MT) scheduling unit configured to schedule and merge instruction flows for the plurality of threads from the instruction memory into a single combined thread of instructions.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a Sutherland asynchronous micropipeline architecture;

FIG. 2 illustrates a token ring architecture;

FIG. 3 illustrates an asynchronous processor architecture;

FIG. 4 illustrates token based pipelining with gating within an arithmetic and logic unit (ALU);

FIG. 5 illustrates token based pipelining with passing between ALUs;

FIG. 6 illustrates a token based single threading processor architecture;

FIG. 7 illustrates an embodiment of a token based multi-threading processor architecture;

FIG. 8 illustrates an example of a multi-threading register window for dual threading;

FIG. 9 illustrates an example of multi-threading scheduling strategies; and

FIG. 10 illustrates an embodiment of a method applying multi-threading using the token based multi-threading processor architecture.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

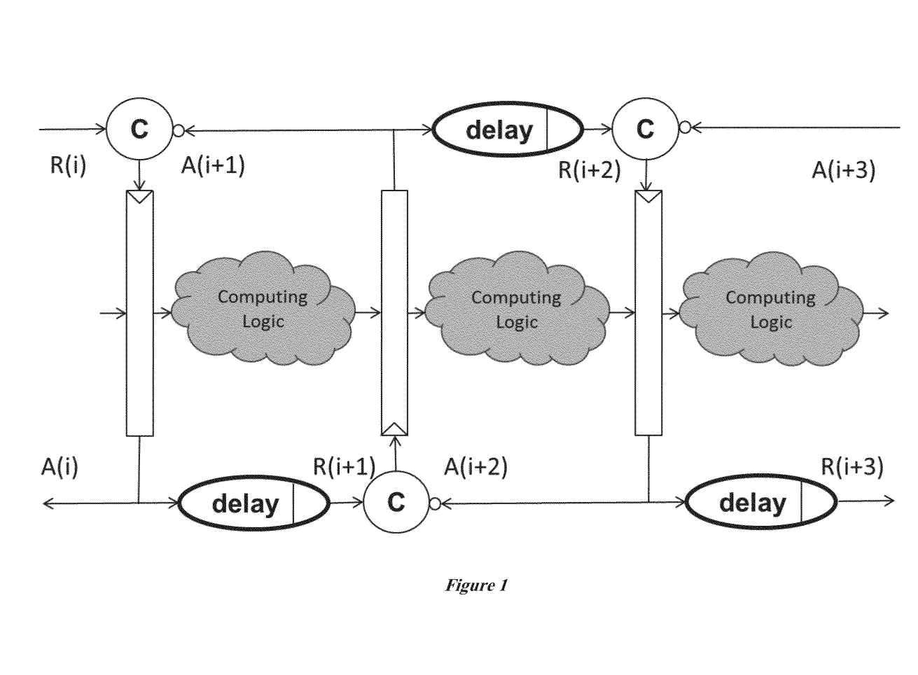

FIG. 1 illustrates a Sutherland asynchronous micropipeline architecture. The Sutherland asynchronous micropipeline architecture is one form of asynchronous micropipeline architecture that uses a handshaking protocol to operate the micropipeline building blocks. The Sutherland asynchronous micropipeline architecture includes a plurality of computing logics linked in sequence via flip-flops or latches. The computing logics are arranged in series and separated by the latches between each two adjacent computing logics. The handshaking protocol is realized by Muller-C elements (labeled C) to control the latches and thus determine whether and when to pass information between the computing logics. This allows for an asynchronous or clockless control of the pipeline without the need for timing signal. A Muller-C element has an output coupled to a respective latch and two inputs coupled to two other adjacent Muller-C elements, as shown. Each signal has one of two states (e.g., 1 and 0, or true and false). The input signals to the Muller-C elements are indicated by A(i), A(i+1), A(i+2), A(i+3) for the backward direction and R(i), R(i+1), R(i+2), R(i+3) for the forward direction, where i, i+1, i+2, i+3 indicate the respective stages in the series. The inputs in the forward direction to Muller-C elements are delayed signals, via delay logic stages The Muller-C element can hold its previous output signal to the respective latch. A Muller-C element sends the next output signal according to the input signals and the previous output signal. Specifically, if the two input signals, R and A, to the Muller-C element have different state, then the Muller-C element outputs A to the respective latch. Otherwise, the previous output state is held. The latch passes the signals between the two adjacent computing logics according to the output signal of the respective Muller-C element. The latch has a memory of the last output signal state. If there is state change in the current output signal to the latch, then the latch allows the information (e.g., one or more processed bits) to pass from the preceding computing logic to the next logic. If there is no change in the state, then the latch blocks the information from passing. This Muller-C element is a non-standard chip component that is not typically supported in function libraries provided by manufacturers for supporting various chip components and logics. Therefore, implementing on a chip the function of the architecture above based on the non-standard Muller-C elements is challenging and not desirable.

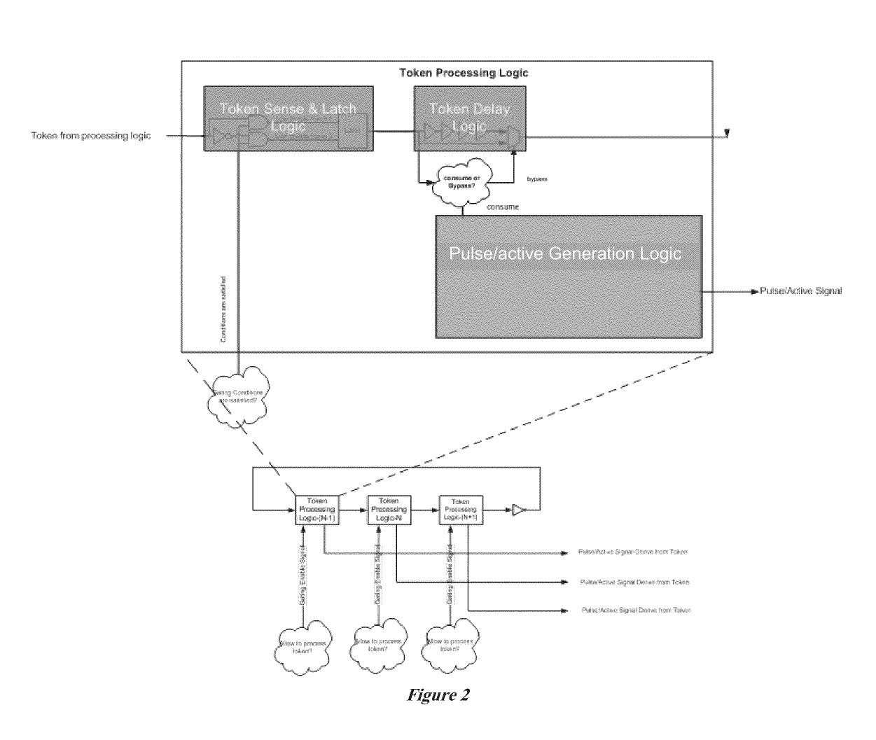

FIG. 2 illustrates an example of a token ring architecture which is a suitable alternative to the architecture above in terms of chip implementation. The components of this architecture are supported by standard function libraries for chip implementation. As described above, the Sutherland asynchronous micropipeline architecture requires the handshaking protocol, which is realized by the non-standard Muller-C elements. In order to avoid using Muller-C elements (as in FIG. 1), a series of token processing logics are used to control the processing of different computing logics (not shown), such as processing units on a chip (e.g., ALUs) or other functional calculation units, or the access of the computing logics to system resources, such as registers or memory. To cover the long latency of some computing logics, the token processing logic is replicated to several copies and arranged in a series of token processing logics, as shown. Each token processing logic in the series controls the passing of one or more token signals (associated with one or more resources). A token signal passing through the token processing logics in series forms a token ring. The token ring regulates the access of the computing logics (not shown) to the system resource (e.g., memory, register) associated with that token signal. The token processing logics accept, hold, and pass the token signal between each other in a sequential manner. When a token signal is held by a token processing logic, the computing logic associated with that token processing logic is granted the exclusive access to the resource corresponding to that token signal, until the token signal is passed to a next token processing logic in the ring.

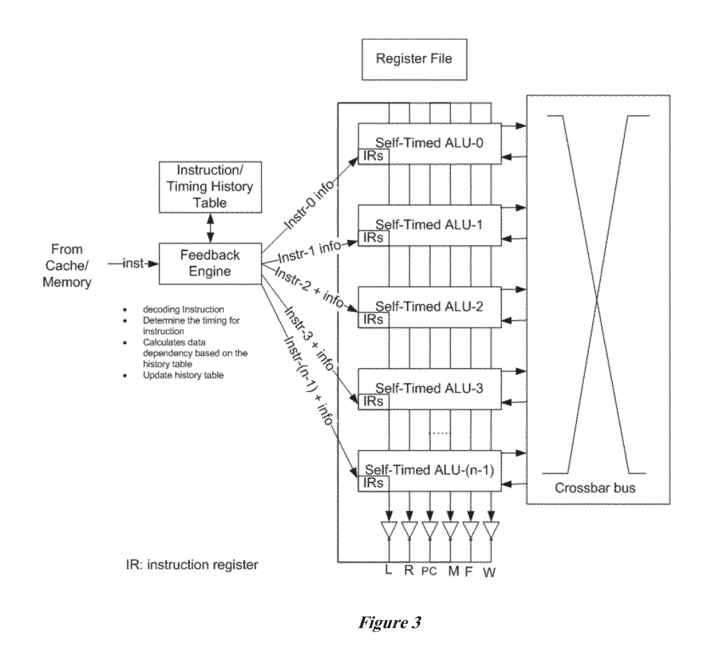

FIG. 3 illustrates an asynchronous processor architecture. The architecture includes a plurality of self-timed (asynchronous) arithmetic and logic units (ALUs) coupled in parallel in a token ring architecture as described above. The ALUs can comprise or correspond to the token processing logics of FIG. 2. The asynchronous processor architecture of FIG. 3 also includes a feedback engine for properly distributing incoming instructions between the ALUs, an instruction/timing history table accessible by the feedback engine for determining data dependency, a register (memory) accessible by the ALUs, and a crossbar for exchanging needed information between the ALUs. The table is used for indicating timing and dependency information between multiple input instructions to the processor system. The instructions from the instruction cache/memory go through the feedback engine which detects or calculates the data dependencies and determines the timing for instructions using the history table. The feedback engine pre-decodes each instruction to decide how many input operands this instruction requires. The feedback engine then looks up the history table to find whether this piece of data is on the crossbar or on the register file. If the data is found on the crossbar bus, the feedback engine calculates which ALU produces the data. This information is tagged to the instruction dispatched to the ALUs. The feedback engine also updates accordingly the history table.

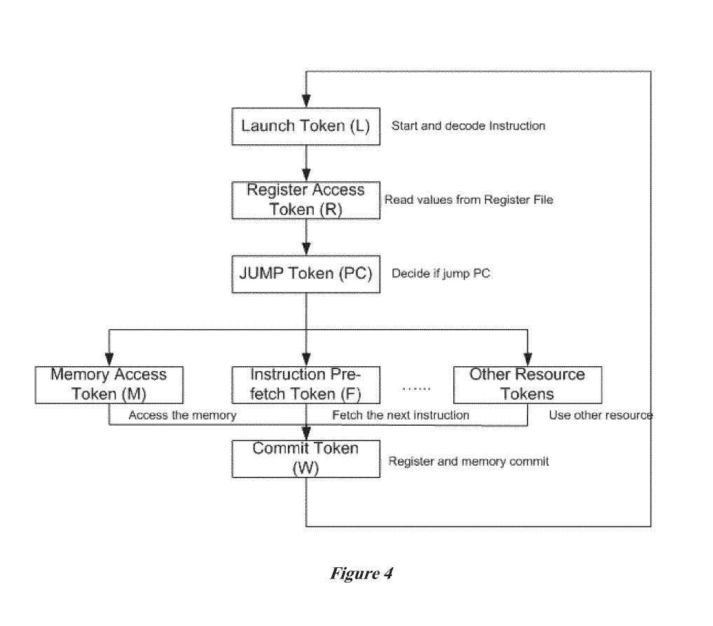

FIG. 4 illustrates token based pipelining with gating within an ALU, also referred to herein as token based pipelining for an intra-ALU token gating system. According to this pipelining, designated tokens are used to gate other designated tokens in a given order of the pipeline. This means when a designated token passes through an ALU, a second designated token is then allowed to be processed and passed by the same ALU in the token ring architecture. In other words, releasing one token by the ALU becomes a condition to consume (process) another token in that ALU in that given order. FIG. 4 illustrates one possible example of token-gating relationship. Specifically, in this example, the launch token (L) gates the register access token (R), which in turn gates the jump token (PC token). The jump token gates the memory access token (M), the instruction pre-fetch token (F), and possibly other resource tokens that may be used. This means that tokens M, F, and other resource tokens can only be consumed by the ALU after passing the jump token. The gating signal from the gating token (a token in the pipeline) is used as input into a consumption condition logic of the gated token (the token in the next order of the pipeline). For example, the launch-token (L) generates an active signal to the register access or read token (R), when L is released to the next ALU. This guarantees that any ALU would not read the register file until an instruction is actually started by the launch-token.

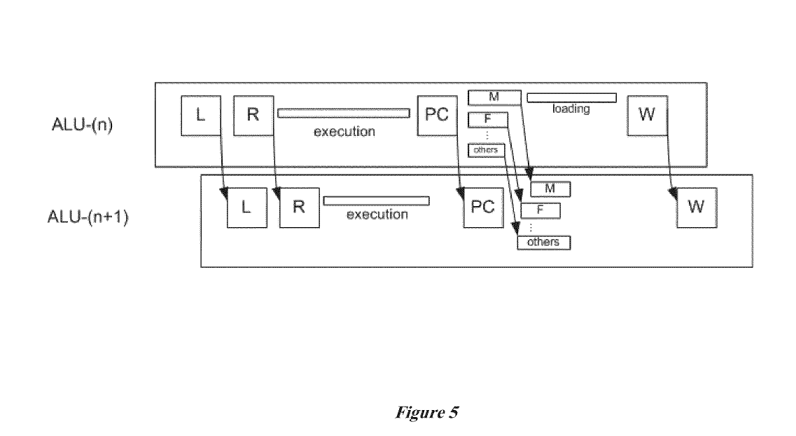

FIG. 5 illustrates token based pipelining with passing between ALUs, also referred to herein as token based pipelining for an inter-ALU token passing system. According to this pipelining, a consumed token signal can trigger a pulse to a common resource. For example, the register-access token (R) triggers a pulse to the register file. The token signal is delayed before it is released to the next ALU for such a period, preventing a structural hazard on this common resource (the register file) between ALU-(n) and ALU-(n+1). The tokens preserve multiple ALUs from launching and committing instructions in the program counter order, and also avoid structural hazard among the multiple ALUs.

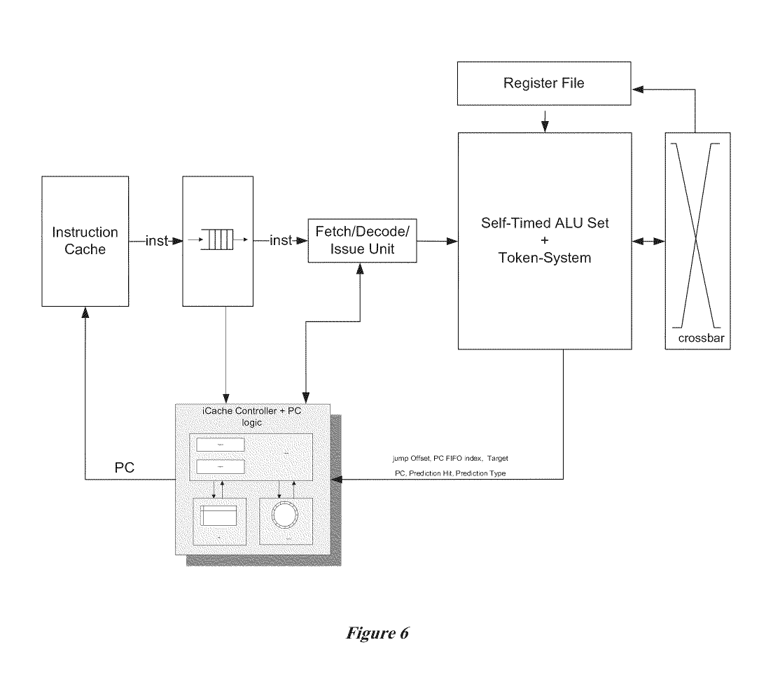

FIG. 6 illustrates a token based single threading processor architecture. The architecture includes a fetch/decode/issue unit that fetches instructions from an instruction cache/memory. The fetch/decode/issue unit early decodes the fetched instructions, detects the data hazard (conflict in resource, such as accessing a same register), calculates the data dependency, and then issues the instructions to the execution unit comprising the self-timed ALU set (described in FIG. 3) in accordance with the token system (described in FIGS. 4 and 5). The execution unit is a clockless functional calculation unit that comprises the set of ALUs implementing a token system. At the execution unit, the ALUs pulse the token signals of the token system. Based on pre-calculated and tagged data dependency information from the fetch/decode/issue unit for each instruction, the ALUs pull the data from a crossbar and output results to the crossbar. A program counter (PC) logic and instruction cache unit (labeled iCache Controller +PC logic in FIG. 6) receives the commands from the fetch/decode/issue unit, performs branch prediction and loop predication, and buffers the issued instructions. The unit also receives a feedback, also referred to herein as change-of-flow feedback, from the execution unit, sends it back to the fetch/decode/issue unit, and sends a target PC address to the instruction cache/memory. The feedback information to the PC logic and instruction cache unit can include a jump offset, a PC first in first out (FIFO) index, a target PC, a prediction hit, a prediction type, or other feedback information from the execution unit. The token system of the execution unit includes a token signal (PC logic token) specific for exclusive access to this PC logic. The components above can be implemented using any suitable chip/circuit design and parts, with or without software.

The token based single threading processor architecture above may not be suitable or efficient for handling multi-threads of instructions using a token-based processor (the execution unit with ALUs). Handling multiple threads of instructions simultaneously or at about the same time can improve the efficiency of the processor. The threads of instructions can be essentially processed independently from each other, e.g., include no or little data dependency. For example, the threads can belong to different programs or software. For handling multi-threads in parallel, e.g., simultaneously or at about the same time, this architecture raises issues including how to handle multiple program counters (PCs) and preserve their own PC order, and how to share the resource between multiple threads. The single threading processor architecture is also not suitable for an efficient multi-thread scheduling strategy. One related issue is how to switch easily different multi-threading (MT) scheduling strategies, and how to make simultaneous MT (SMT) possible.

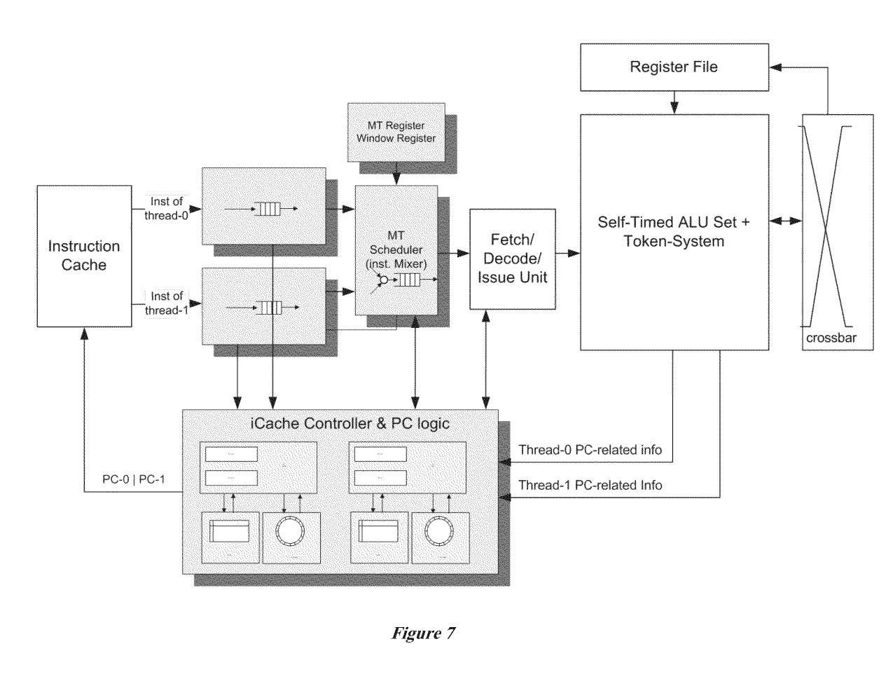

FIG. 7 illustrates an embodiment of a token based multi-threading processor architecture that can resolve the issues above. A fetch/decode/issue unit performs similar to that of the token based single threading processor above. Similarly, an execution unit is configured as described above. However, this architecture includes a PC logic and instruction cache unit that is configured to duplicate or initiate the PC logic of the single threading processor above proportionally to the number of threads. Thus, a PC logic is dedicated for each considered thread, as shown in FIG. 7. In an embodiment, the PC logics are pre-established, via hardware, and then activated as needed to handle the number of threads. The number of available PC logics determines the maximum number of the threads that the processor could support. In an embodiment, the PC logics are generated according to a desired number or maximum number of threads to be handled. The PC logics can operate on their respective threads essentially independent from each other, e.g., without or with little data dependency. The architecture also includes a MT scheduling unit (labeled MT scheduler) that is configured to act as an instruction mixer of the multiple threads. Specifically, the MT scheduling unit schedules and merges the instruction flows of the multiple threads from the instruction cache into a combined thread, and maps registers for operands using a MT register window register. The combined threads by this merger is then forwarded to the fetch/decode/issue unit, and operated on as a single thread. The MT scheduling unit can also communicate with the PC logic and instruction cache unit to exchange necessary information regarding the multiple threads. The other components of the token based multi-threading processor architecture can be configured similar to the corresponding components of the token based single threading processor architecture above. Using the duplicate PC logics in the PC logic and instruction cache unit (labeled iCache controller and PC logic) and the MT scheduling unit to handle the multiple threads separately and then merge the threads into a single thread allows reusing the same other components of the single thread architecture and simplifies design.

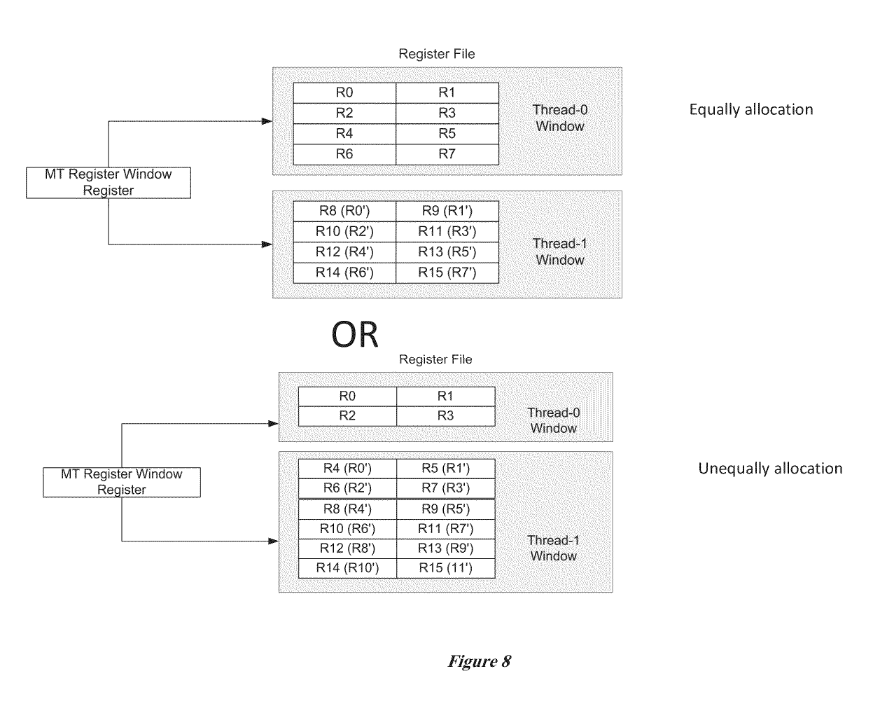

FIG. 8 illustrates an example of a MT register window register for dual-threading (e.g., for handling two simultaneous threads), which can be implemented using the token based multi-threading processor architecture above. The MT register window register can allocate the register file for two threads, e.g., between Thread-0 and Thread-1, with equal or non-equal number of registers. Using equal register file allocation, each of the two threads is allocated an equal number of registers for handling the corresponding thread instructions, e.g., R0 to R7 for Thread-0 and R8 to R15 for Thread-1. The allocated group of registers in the file to a thread of instructions is also referred to herein as a register window. Alternatively, unequal allocation of the registers in the register file may be used, for instance to accelerate or dedicate more resource to one of the threads. For example, R4 to R15 are allocated to Thread-1, leaving R1 to R4 for Thread-0. In either case, the operands (operations in the instruction threads) of each thread can be mapped to a group of registers (or a register window) in the register file. For example, using equal allocation, Thread-1 is mapped in a window including the registers R8 to R15. The eight registers in this window can be labeled as R0′ to R7′. Alternatively, using non-equal allocation, Thread-1 is mapped in a window including the registers R4 to R15. The eight registers in this window can be labeled as R0′ to R11′. Other examples can include more than two threads with equal or non-equal number of registers.

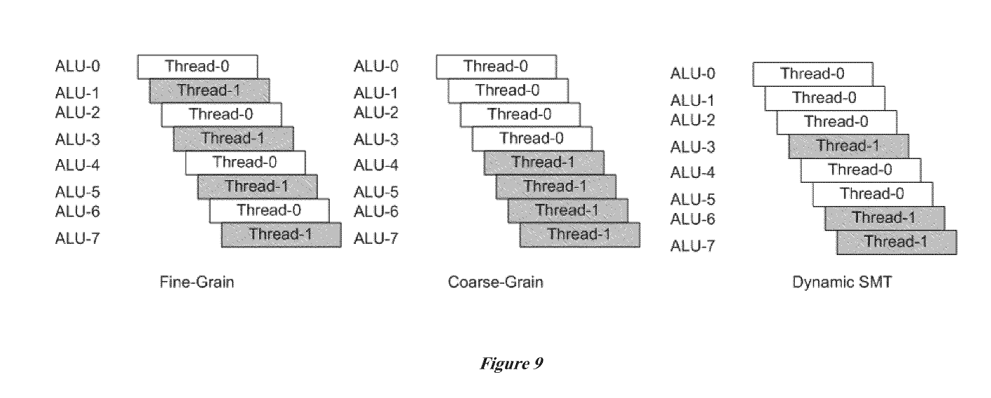

FIG. 9 illustrates an example of multi-threading scheduling strategies which can be implemented using the token based multi-threading processor. This token-based MT processor architecture allows different MT scheduling strategies for allocating multiple ALUs to multiple threads of instructions. The example strategies include fine-gain scheduling (interleaving), coarse-gain (blocking), and SMT. Using fine-gain scheduling, the ALUs can be allocated to the threads (e.g., Thread-0 and Thread-1) in alternating order as shown. Using coarse-gain scheduling, a chosen number of consecutive ALUs are allocated to the two threads in alternating order. Using dynamic SMT, the ALUs are allocated to the threads on the run dynamically as needed. The examples are shown for the case of dual-threading. However, the strategies can be extended to any number of threads. The strategies can be switched on the run (during instruction processing) by the instruction, for example. Further, the number of threads can be changed on the run.

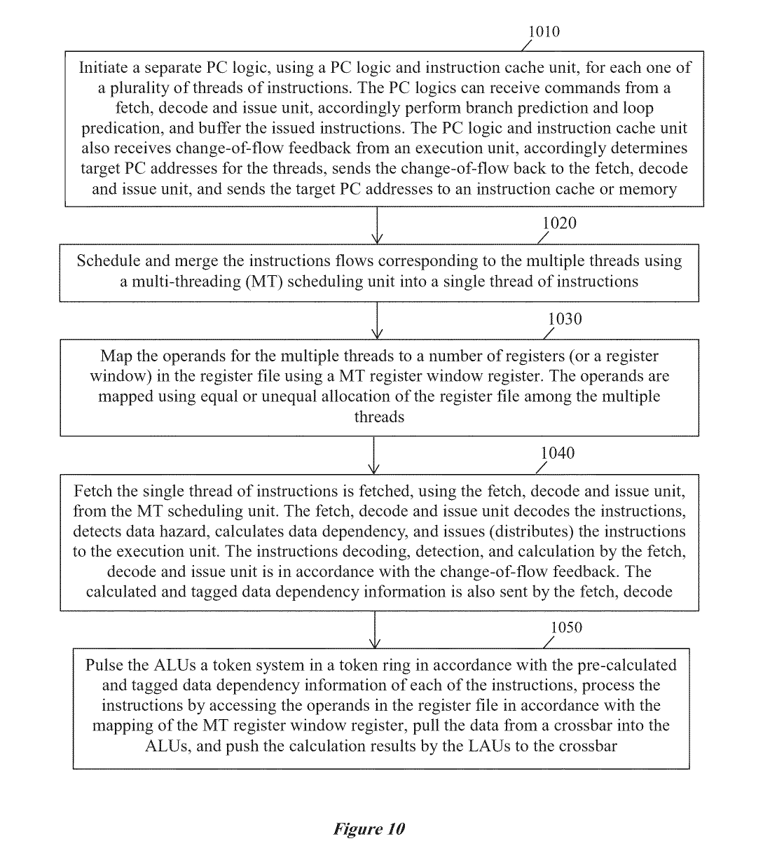

FIG. 10 shows an embodiment method applying multi-threading using the token based multi-threading processor architecture. At step 1010, a separate PC logic is initiated, using a PC logic and instruction cache unit, for each one of a plurality of threads of instructions. The PC logics can receive commands from a fetch, decode and issue unit, accordingly perform branch prediction and loop predication, and buffer the issued instructions. The PC logic and instruction cache unit also receives change-of-flow feedback from an execution unit, accordingly determines target PC addresses for the threads, sends the change-of-flow back to the fetch, decode and issue unit, and sends the target PC addresses to an instruction cache or memory. At step 1020, the instructions flows corresponding to the multiple threads are scheduled and merged using a multi-threading (MT) scheduling unit into a single thread of instructions. At step 1030, the operands for the multiple threads are mapped to a number of registers (or a register window) in the register file using a MT register window register, as described above. The operands are mapped using equal or unequal allocation of the register file among the multiple threads. At a step 1040, the single thread of instructions is fetched, using the fetch, decode and issue unit, from the MT scheduling unit. The fetch, decode and issue unit decodes the instructions, detects data hazard, calculates data dependency, and issues (distributes) the instructions to the execution unit. The instructions decoding, detection, and calculation by the fetch, decode and issue unit is in accordance with the change-of-flow feedback. The calculated and tagged data dependency information is also sent by the fetch, decode and issue unit to the ALUs in the execution unit. At step 1050, the ALUs pulse a token system in a token ring in accordance with the pre-calculated and tagged data dependency information of each of the instructions, process the instructions by accessing the operands in the register file in accordance with the mapping of the MT register window register, pull the data from a crossbar into the ALUs, and push the calculation results by the ALUs to the crossbar. The steps of the method can be performed continuously in a cycle, e.g., to handle incoming instructions to the processor.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by an asynchronous processor, the method comprising:
receiving a plurality of threads of instructions from an execution unit of the asynchronous processor;
initiating, for the plurality of threads of instructions, a plurality of corresponding program counter (PC) logics at a PC logic and instruction cache unit of the asynchronous processor;
performing, using each one of the PC logics, branch prediction and loop predication for one corresponding thread of the plurality of threads of instructions;
determining, using each one of the PC logics, a target PC address for the one corresponding thread; and
caching the one corresponding thread in an instruction memory in accordance with the target PC address.

2. The method of claim 1 further comprising scheduling and merging, using a multi-threading (MT) scheduling unit of the asynchronous processor, the plurality of threads of instructions from the instruction memory into a single combined thread of instructions.

3. The method of claim 2 further comprising:
fetching, using a fetch, decode and issue unit, the single combined thread of instructions from the MT scheduling unit;
decoding the instructions, using the fetch, decode and issue unit;
detecting a data hazard in the instructions, using the fetch, decode and issue unit;
calculating data dependency in the instructions, using the fetch, decode and issue unit; and
issuing the instructions to the execution unit.

4. The method of claim 3 further comprising receiving, at the PC logic and instruction cache unit, commands from the fetch, decode and issue unit, wherein the branch prediction and the loop predication is performed in accordance with the commands from the fetch, decode and issue unit.

5. The method of claim 3 further comprising:
receiving, at the PC logic and instruction cache unit, change-of-flow feedback from the execution unit, wherein the target PC address is determined in accordance with the change-of-flow feedback; and
sending the change-of-flow feedback to the fetch, decode and issue unit, wherein the decoding, detecting, and calculating using the fetch, decode and issue unit is in accordance with the change-of-flow feedback.

6. The method of claim 1 further comprising mapping, using a MT register window register, operands in the plurality of threads of instructions to a plurality of corresponding register windows in a register file.

7. The method of claim 6 further comprising allocating in the register windows for the plurality of threads a same number of registers in the register file.

8. The method of claim 6 further comprising allocating, in the register windows for the plurality of threads, respective numbers of registers in accordance with resource demand for the plurality of threads.

9. The method of claim 6 further comprising:
passing and gating, in accordance with a predefined order of token pipelining and token-gating relationship, a plurality of tokens through a plurality of arithmetic and logic units (ALUs) of the execution unit, wherein the ALUs are arranged in a ring architecture;
processing the instructions at the ALUs by accessing the operands in the register file in accordance with the mapping of the MT register window register;
pulling data from a crossbar of the asynchronous processor into the ALUs in accordance with pre-calculated and tagged data dependency information of the instructions issued to the execution unit; and
pushing calculation results from the ALUs to the crossbar.

10. A method performed at an asynchronous processor, the method comprising:
initiating, at a program counter (PC) logic and instruction cache unit, a plurality of PC logics for handling multiple threads of instructions;
performing, using each one of the PC logics, branch prediction and loop predication for one corresponding thread of the multiple threads;
determining, using each one of the PC logics, a target PC address at an instruction memory for caching the one corresponding thread;
caching the one corresponding thread in the instruction memory in accordance with the target PC address; and
scheduling and merging, using a multi-threading (MT) scheduling unit, instruction flows corresponding to the multiple threads from the instruction memory into a single combined thread of the instructions.

11. The method of claim 10, wherein the PC logics are preset in the PC logic and instruction cache unit, and wherein initiating the PC logics comprises activating a number PC logics in the PC logic and instruction cache unit in accordance with a total number of the threads.

12. The method of claim 10, wherein initiating the PC logics comprises generating a number PC logics in the PC logic and instruction cache unit in accordance with a total number of the threads.

13. The method of claim 10 further comprising mapping, by a MT register window register, operands of the multiple threads into corresponding register windows in a register file.

14. The method of claim 10 further comprising:
fetching, at a fetch, decode and issue unit of the asynchronous processor, the single combined thread of the instructions from the MT scheduling unit;
decoding the instructions; and
sending the decoded instructions to an execution unit.

15. The method of claim 14 further comprising:
processing the instructions at a plurality of arithmetic and logic units (ALUs) arranged in a ring architecture in the execution unit by accessing the operands in the register file in accordance with the mapping of the MT register window register; and
sending, from the execution unit to the PC logic and instruction cache unit, feedback information for each one of the multiple threads.

16. The method of claim 15 further comprising allocating the ALUs to the threads using fine-gain scheduling, wherein the ALUs are allocated to the threads in alternating order.

17. The method of claim 15 further comprising allocating the ALUs to the threads using coarse-gain scheduling, wherein a chosen number of consecutive ALUs are allocated to the threads in alternating order.

18. The method of claim 15 further comprising allocating the ALUs to the threads using dynamic simultaneous MT (SMT), wherein the ALUs are allocated to the threads during processing time dynamically as needed.

19. An apparatus for an asynchronous processor supporting multiple threading, the apparatus comprising:
a program counter (PC) logic and instruction cache unit comprising a plurality of PC logics configured to perform branch prediction and loop predication for a plurality of threads of instructions, and determine target PC addresses for caching the plurality of threads;
an instruction memory configured to cache the plurality of threads in accordance with the target PC addresses from the PC logic and instruction cache unit; and
a multi-threading (MT) scheduling unit configured to schedule and merge instruction flows for the plurality of threads from the instruction memory into a single combined thread of instructions.

20. The apparatus of claim 19 further comprising a MT register window register configured to map operands in the plurality of threads to a plurality of corresponding register windows in a register file, wherein allocating in the register windows for the plurality of threads are allocated a same or different number of registers in the register file.

21. The apparatus of claim 20 further comprising:
an execution unit comprising a plurality of arithmetic and logic units (ALUs) arranged in a ring architecture and configured to process the instructions;
a cross bar configured to exchange data and calculation results between the ALUs; and
a fetch, decode and issue unit configured to fetch the single combined thread of instructions from the MT scheduling unit, decode the instructions, and issue the decoded instructions to the ALUs.

22. The apparatus of claim 21, wherein the ALUs are configured to process the instructions by accessing the operands in the register file in accordance with the mapping of the MT register window register.

23. The apparatus of claim 21, wherein the execution unit is further configured to send change-of-flow feedback to the PC logic and instruction cache unit, and wherein PC logics are configured to determine the target PC addresses in accordance with the change-of-flow feedback.

24. The apparatus of claim 21, wherein the fetch, decode and issue unit is configured send commands to the PC logic and instruction cache unit, and wherein the PC logics perform the branch prediction and the loop predication in accordance with the commands.
